(19) United States
(12) Patent Application Publication
(10) Pub. No.: US 2008/0250879 A1
(43) Pub. Date: Oct. 16, 2008

(54) LIQUID CORE SAMPLING DEVICE AND FLOAT

(76) Inventor: Curtis Duff, Spring Creek, NV (US)

Correspondence Address: BATEMAN IP LAW GROUP, P.O. BOX 1319, SALT LAKE CITY, UT, 84110, US

(21) Appl. No.: 12/101,779

(22) Filed: Apr. 11, 2008

Related U.S. Application Data
(60) Provisional application No. 60/911,571, filed on Apr. 13, 2007.

(51) Int. Cl. G01N 1/12

(52) U.S. Cl. 73/864.65

(57) ABSTRACT

An improved liquid sampling device provides a buoyant handle which reduces the likelihood that the device will fall into a body of liquid and provides greater operator control of the device. The handle and a loop facilitate removal of the sampling device from a liquid if it has fallen therein.

### RELATED APPLICATIONS

The present application claims the benefit of U.S. Provisional Application Ser. No. 60/911,571, filed Apr. 13, 2007, which is incorporated herein by reference in its entirety.

### BACKGROUND OF THE INVENTION

1. The Field of the Invention

The present invention relates to a liquid core sampling device and a float handle for use with such a core sampling device.

2. State of the Art

In the water treatment industry, settling and processing tanks are used which contain both a layer of sediment at the bottom of the tank and a layer of water above the sediment. Water flows into and out of the tank, and the flow rate of the water and other tank parameters are often adjusted to thereby control the sediment level in the tank. It is typically desirable to maintain a consistent depth of sediment in the tank. Liquid sampling tubes are used to check the depth of sediment in the tank.

A problem which occurs with the currently available liquid sampling tubes is that the tubes are difficult to hold and use, and therefore prone to being dropped in the settling tank. once dropped in the tank, the tube will move to the bottom of the tank, and may be obscured in the sediment. It is difficult to remove the sampling tube from the tank, and the tank often must be drained to retrieve the tube, resulting in considerable expense and downtime. If not removed from the tank, the sampling tube may eventually become jammed in the pipes or pumping equipment associated with the tank, causing additional damage and repairs.

There is thus a need for a sampling device which overcomes the limitations of available sampling tubes. Specifically, there is a need for a sampling device which is easier to use and which reduces the likelihood of dropping the device, and which, if dropped, is more easily retrieved from the tank without the need for draining the tank.

### SUMMARY OF THE INVENTION

It is an object of the present invention to provide an improved liquid core sampling device and float handle.

According to one aspect of the invention, a liquid core sampling device is provided with a floating handle. The floating handle provides a convenient grip which facilitates easier use of the core sampling device. Additionally, the floating handle ensures that a portion of the sampling device is maintained at or near the surface of the liquid if the sampling device is dropped into a tank. According to another aspect of the present invention, the liquid core sampling device is provided with a loop or ring other means for allowing the device to be more easily removed if accidentally dropped into a tank.

These and other aspects of the present invention are realized in a liquid core sampling device as shown and described in the following figures and related description.

### BRIEF DESCRIPTION OF THE DRAWINGS

Various embodiments of the present invention are shown and described in reference to the numbered drawings wherein:

FIG. 1 shows a side view of a liquid sampling device according to the present invention;

FIG. 2 shows a partially cut-away view of the stop valve of the device of FIG. 1;

FIG. 3 shows the handle of the device of FIG. 1;

FIG. 4 shows an alternate handle for the device of FIG. 1;

FIG. 5 shows an alternate handle for the device of FIG. 1;

FIG. 6 shows an alternate handle for the device of FIG. 1; and

FIG. 7 shows a side view of the device of FIG. 1 in use.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single FIGURE, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

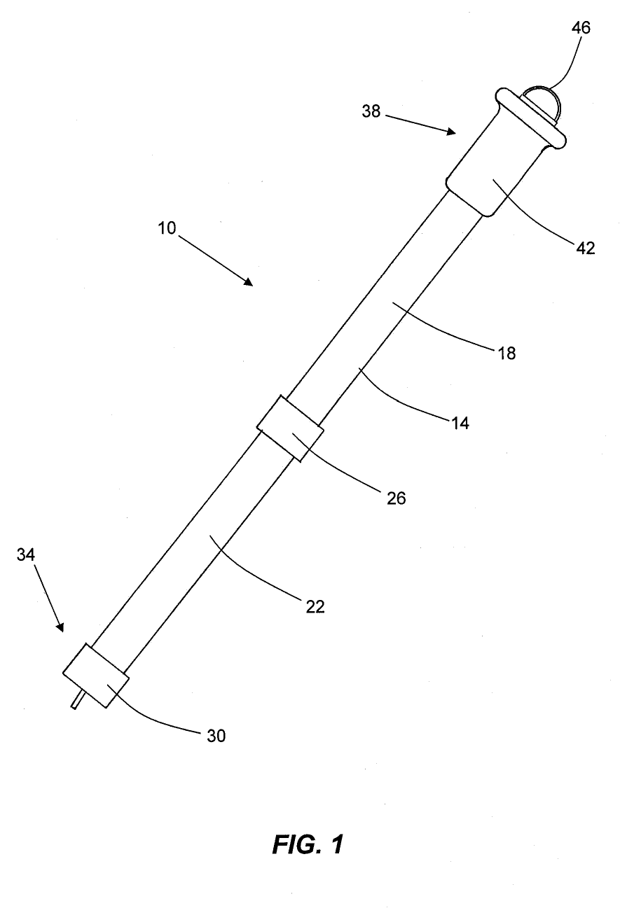

Turning now to FIG. 1, a side view of a liquid core sampling device 10 is shown. The sampling device 10 includes a tubular body 14 which is typically formed of various tube sections 18, 22. The tube sections 18, 22 are typically about one and one half inches in diameter. The tube sections 18, 22 are attached together by a coupler 26, such as by threading the tube sections 18, 22 together. Thus, the tube sections 18, 22 may be detached at coupler 26 and an additional coupler and tube section may be inserted there between to increase the length of the sampling device 10. The tube sections 18, 22 may be provided in lengths of about five feet, allowing the sampling device 10 to be used in convenient lengths such as ten, fifteen, and twenty feet, etc.

A stop valve 30 is placed on the bottom end 34 of the sampling device 10 (the end inserted into a tank of liquid). The stop valve 30 allows liquid to flow into the tubular body 14 of the sampling device 10, and keeps the liquid in the device when it is withdrawn from the tank. The upper end 38 of the sampling device 10 has a handle 42 formed thereon. The handle 42 is made of a material with a density less than the density of water and other common liquids such that the handle will float in the liquids. According to a preferred embodiment, the handle 42 has a density less than 0.8 g/mL and will thus provide buoyancy in many liquids including water and many oils. According to a more preferred embodiment, the handle has a density less than 0.1 g/mL. The handle 42 is preferably made of closed cell foam such as polyurethane foam or other suitable material. Preferably, the handle 42 does not absorb liquid when immersed therein. The upper end 38 of the sampling device 10 also includes a loop 46 which may be formed as a plastic or metal ring or the like.

The sampling device 10 is often used to sample the liquid and sediments in a settling tank in a water treatment plant, or is similarly used to sample other liquids in tanks. In such a settling tank, the sampling device 10 is pushed downwardly to the bottom of the tank, allowing the liquid and sediment to enter the tubular body 14. The device 10 is then drawn from the tank, allowing the tank operator to see the liquid and sediment and determine desired parameters such as the sediment or liquid depth. In a water treatment plant, the tanks may be checked many times during the day.

It will be appreciated that the sampling device 10 may be quite heavy when filled with liquid, as the liquid depth may be 10 feet or more. The handle 42 provides a surface which is more easily gripped than the tube 18, and thus makes it less likely that the sampling device 10 is dropped into the settling tank. Additionally, the handle 42 will keep the upper end 38 of the sampling device at or near the surface of a liquid if the sampling device 10 is dropped in the liquid. The buoyant handle 42 thus makes it easier to see where the sampling device is located if dropped into a tank, and makes it easier to retrieve the device 10 by keeping the upper end 38 of the device near the top of the tank. The loop 46 provides an area which is easily captured by a hook, allowing a worker to retrieve the sampling device 10 from a tank by using a pole with a hook on the end.

Without such a handle 42, the sampling device 10 would sink to the bottom of the tank and may be obscured by sediment in the tank. Workers may not desire to retrieve the sampling device from the tank, as it may involve wading into the tank or draining the tank. If the sampling device is not retrieved, it may block a pipe, valve, or pump and cause further damage or disruption. Thus, the floatation handle 42 and loop 46 are advantageous in allowing the sampling device 10 to be easily removed from the tank.

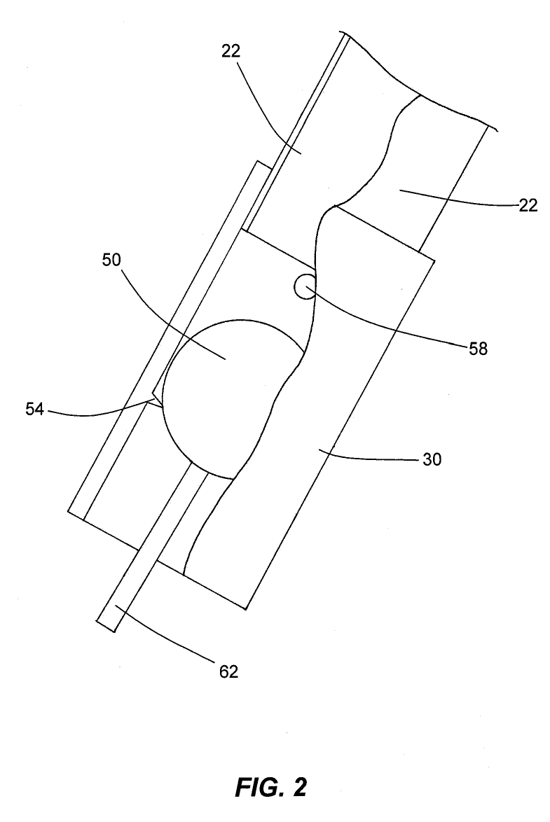

Turning now to FIG. 2, a partially cut-away view of the stop valve 30 is shown. The stop valve 30 allows liquid to enter the tube section 22 but prevents the liquid from exiting the tube until desired. The stop valve 30 may contain a ball 50 and annular flange 54 or other known configuration. The ball 50 can move upwardly until contacting a cross-member 58, allowing liquid to flow around the ball and into the tube section 22. When liquid attempts to flow out of the tube 22, the ball 50 is pressed against the annular flange 54, forming a seal which prevents the liquid from exiting the tube. A post 62 may be attached to the ball 50. When an operator desires to empty the sampling device, the post 62 may be pressed upwardly to move the ball 50 away from the annular flange 54 so as to allow the liquid to exit the tube 22.

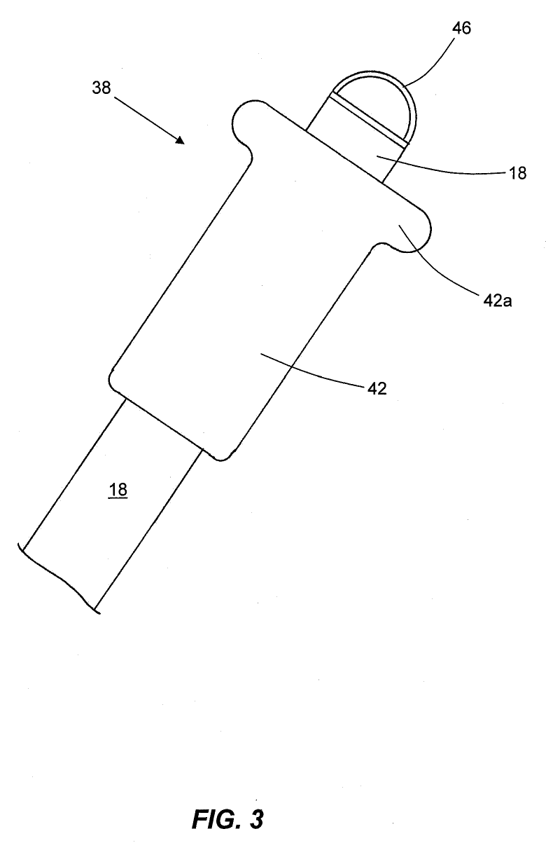

Turning now to FIG. 3, a detailed view of the handle 42 is shown. The upper end 38 of the tube 18 is typically open to allow air to easily exit and enter the body 14 when the device 10 is in use. As have been discussed, the handle 42 and loop 46 make it less likely that the sampling device is dropped into a tank, and make it easier to remove the sampling device if dropped. The handle 42, if flexible, may provide a cushioned grip which is easier to hold. Additionally, the handle 42 is larger than the tube 18 and may include a flange 42a etc., to prevent the tube from accidentally sliding through the hands of a user. As such, the handle 42 may provide greater operator control over the sampling device 10.

A variety of different materials may be utilized to form the handle, such as foam and other flexible materials, or even rigid plastic may be used. A handle 42 may be formed from rigid plastics which has air pockets therein to create buoyancy. The loop 46 may be metal, plastic, rope, etc. and may be attached to one or more edges of the tube 18. The loop 46 should be of sufficient size and strength to allow the sampling device 10 to be lifted out of a tank by the loop.

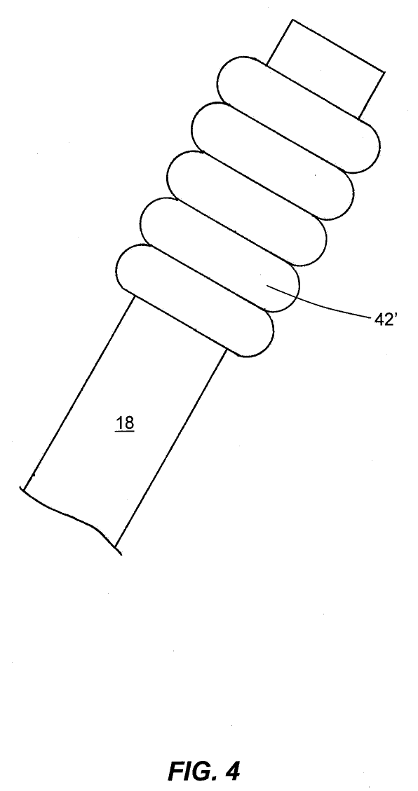

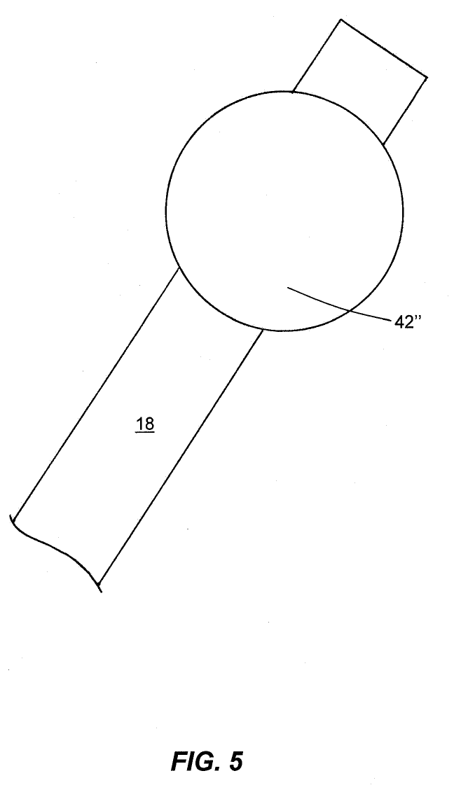

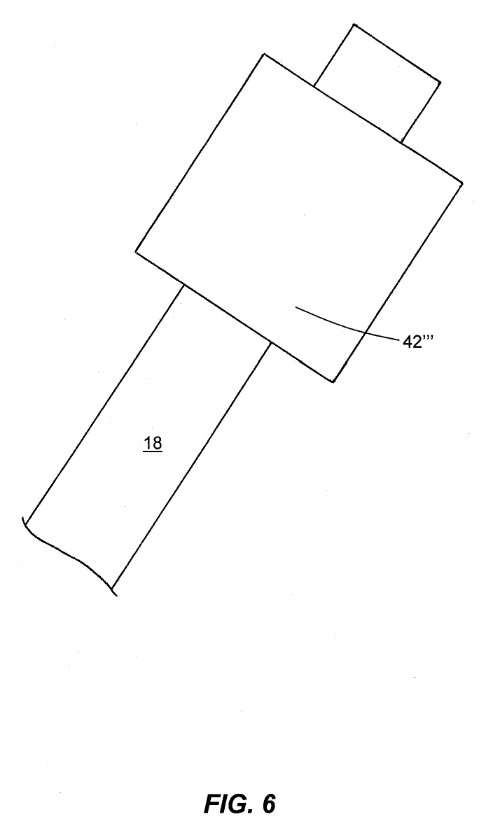

FIGS. 4, 5, and 6 show alternate shapes of the handle 42. Other structures, such as loop 46, have been omitted for clarity. It can be seen how the handle 42 may be formed in a variety of different shapes, such as ribbed handle 42′, spherical handle 42″, or cube shaped handle 42′″. The handle 42 and loop 46 provide significant advantages in reducing the likelihood that the liquid sampling device 10 will fall into a tank or other body of liquid, and also facilitate recovery of the device 10 if it were to fall into a liquid.

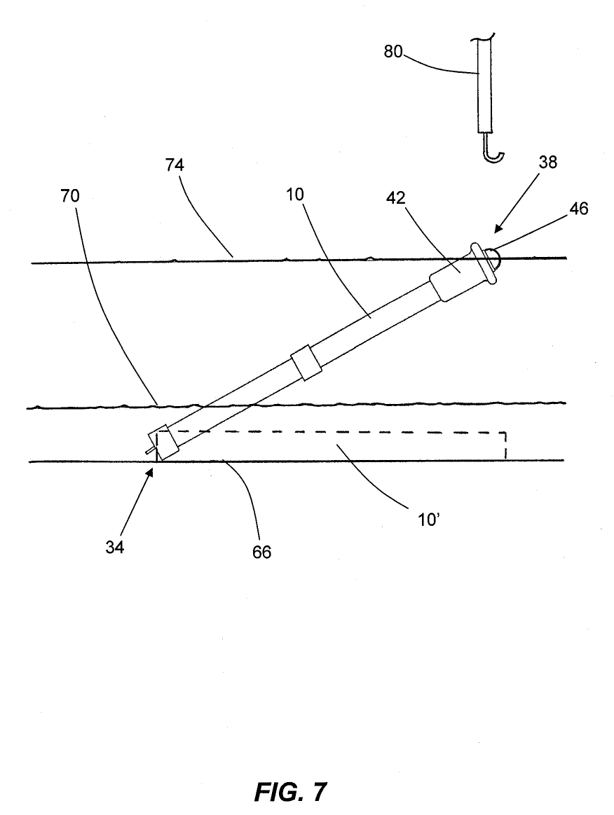

FIG. 7 illustrates how the handle 42 facilitates easy recovery of the sampling device 10. The sampling device 10 is shown in a tank which contains both a sediment 70 and liquid 74. The lower end 34 of the device 10 is resting on the bottom 66 of the tank. If dropped by the worker, the device 10 comes to rest in the position shown, where the buoyant handle 42 keeps the upper end 38 at or near the surface of the liquid 74 where the loop 46 is accessible and where the sampling device 10 may be easily recovered. Without the buoyant handle 42, the sampling device 10 would likely sink to the position shown at 10′. The sampling device 10 would then be difficult to recover as it is under the sediment 70 and difficult to see. With the present invention, however, a hook 80 can be used to engage the loop 46 and then pull the sampling device 10 from the tank. Such an arrangement both helps keep the sampling device 10 from being dropped as well as making it easier to recover the sampling device.

In some cases, workers fall into the settling tanks while trying to catch a dropped sampling device 10. As conventional sampling devices are difficult to find and recover from a settling tank, a user will often quickly reach after a slipping or dropped sampling device before it slips under the water or liquid in the tank. This may cause the worker to lose their balance and fall into the tank. The present invention reduces that risk as the worker knows that the sampling device is fairly simple to recover from the tank. The worker can simply let the device fall into the tank without jeopardizing their own safety as they know that they can simply use a hook to retrieve the sampling device.

There is thus disclosed an improved liquid core sampling device. It will be appreciated that numerous changes may be made to the present invention without departing from the scope of the claims.

What is claimed is:

1. A liquid sampling device comprising:
a hollow tubular body having a first end and a second end;
a stop valve on the first end of the body, the stop valve being configured for selectively maintaining a fluid within the body;
a handle disposed adjacent the second end of the body, the handle being formed so as to have a bulk density lower than that of water so as to be buoyant in water.

2. The device of claim 1, wherein the handle is formed from a foam.

3. The device of claim 1, wherein the handle has a flange formed thereon.

4. The device of claim 1, further comprising a loop formed adjacent the second end of the body, the loop being disposed so as to allow the lifting of the device with the loop.

5. The device of claim 4, wherein the loop is disposed so as to extend from the second end of the body so as to allow a hook to be placed through the loop to thereby lift the device.

6. The device of claim 1, wherein the body comprises multiple tube sections releasably attached together.

7. The device of claim 1, wherein the body is formed from a transparent plastic.

8. The device of claim 7, wherein the body has measurement markings thereon so as to allow a user to visually check the height of the various materials disposed within the body.

9. The device of claim 1, wherein the stop valve has a post extending therefrom, and wherein pressing on the post will selectively allow the contents of the device to pass through the stop valve.

10. A method for facilitating recovery of a liquid sampling device comprising:
selecting a liquid sampling device comprising a hollow tubular body having a stop valve disposed on a first end of the body;
selecting a handle, the handle being formed from a material which is buoyant in water; and
attaching the handle to a second end of the body such that the second end of the liquid sampling device will be held near the surface of a body of water if the liquid sampling device is accidentally dropped in said body of water.

11. The method of claim 10, further comprising:
attaching a loop to the second end of the body so as to facilitate engagement of the loop by a hook to thereby retrieve the sampling device from a body of water.

12. The method of claim 10, wherein the method comprises selecting a liquid sampling device which comprises a clear body so as to enable visual recognition of the contents of the body, and wherein the body further comprises graduated markings on the exterior thereof so as to allow for visual identification of the heights of the various materials disposed within the body.

13. The method of claim 10, wherein the liquid sampling device is configured for insertion into a settling tank so as to draw liquid and sediment into the body to thereby allow a user to measure the height of the liquid and sediment.

14. A liquid sampling device comprising:
a tubular body having a first end and a second end, the tubular body being formed from a clear plastic so as to allow visual recognition of the contents of the tubular body;
a stop valve disposed on the first end of the tubular body, the stop valve being configured to allow liquid to enter the body and to selective prevent liquid from exiting the body such that the first end of the body may be inserted into a liquid filled settling tank and then withdraw from the settling tank to thereby remove a core sample of the settling tank, the core sample showing the heights of the sediment and liquid in the settling tank;
a handle disposed on the second end of the tubular body, the handle having a density less than that of water such that if the liquid sampling device is dropped into a tank of water the second end of the body is maintained adjacent the surface of the water to facilitate removal of the liquid sampling device from the water.

15. The device of claim 14, wherein the device further comprises a loop disposed adjacent the second end of the body and extending therefrom, the loop being configured for allowing a hook to be passed therethrough to thereby lift the sampling device.

16. The device of claim 14, wherein the body has graduated markings thereon so as to allow a person to visually determine the height of the contents of the sampling device.

17. The device of claim 14, wherein the body is formed from multiple sections which are removably connected together, and wherein the number of sections may be changed to vary the length of the sampling device.
